(19) United States
(12) Patent Application Publication
(10) Pub. No.: US 2014/0007110 A1
(43) Pub. Date: Jan. 2, 2014

(54) NORMALIZED INTERFACE FOR TRANSACTION PROCESSING SYSTEMS

(71) Applicant: Jonathan Daniel Cordero, Orlando, FL (US)

(72) Inventor: Jonathan Daniel Cordero, Orlando, FL (US)

(73) Assignee: NCR Corporation, Duluth, GA (US)

(21) Appl. No.: 13/537,678

(22) Filed: Jun. 29, 2012

(51) Int. Cl. G06F 9/46

(52) U.S. Cl. 718/101

(57) ABSTRACT

Normalized interface for heterogeneous transaction processing systems are provided. One or more disparate transaction processing systems include an interface and a set of operations. When a user attempts to access the transaction processing systems, a normalized interface is presented having a normalized set of operations that map to the set of operations and the interface of the transaction processing systems. The user interacts with the normalized interface as if directly interacting with the transaction processing systems.

### BACKGROUND

Consumers are increasingly using kiosks to conduct business with enterprises. The kiosks come in a variety of sizes and are used for a variety of purposes. Some kiosks are drive through, such as fast food establishments, pharmacies, banks, and the like. Other kiosks are stationary located in gas stations, airlines, grocery stores, department stores, and the like.

In addition, what is considered a kiosk is evolving with today's technology. For example, digital signs now provide advertisements and mechanisms for users to interact with the displays to perform transactions. Such mechanisms include blue tooth communication, Near Field Communication (NFC), Quick Response (QR) code scanning, Wi-Fi communication, and the like.

Even websites and stores online may be viewed as a form of a kiosk. A tremendous amount of services are now available online via website portals. Business even attempt to tie their backend systems to existing website services offered by third parties.

By and Large, Large scale Self Service Device (SSD) systems (and websites/applications) must communicate with a heterogeneous mixture of reservation and service providers via numerous disparate and independent interfaces. Many of these interfaces provide similar functionality but must be used in conjunction with custom business rules to provide a complete solution. These interfaces, in combination with custom software, generally use a combination of web services, file transfers, databases, messages, or screen-scraping processes as ad-hoc gateways to communicate with vendor systems.

Even though multiple customers may be using services from a same host, it can be difficult to maintain a common host integration codebase due to the presence of customer-specific logic. Additionally, it is difficult for a customer to transition from one host to another host when the customer-specific business logic is strongly tied to the integration code.

### SUMMARY

In various embodiments, techniques for providing a normalized interface to transaction processing systems are presented. According to an embodiment, a method for providing a normalized interface to a transaction processing system is provided.

Specifically, a first set of operations is acquired; the first set of operations is directed to a first transaction processing system. Next, a normalized interface is presented having a normalized set of operations that are presented in place of the first set of operations when the first transaction processing system is interfaced with.

### BRIEF DESCRIPTION OF THE DRAWINGS

FIG. 1 is a diagram of a method for providing a normalized interface to a transaction processing system, according to an example embodiment.

FIG. 2 is a diagram of another method for providing a normalized interface to a transaction processing system, according to an example embodiment.

FIG. 3 is a diagram of a normalized interface system, according to an example embodiment.

### DETAILED DESCRIPTION

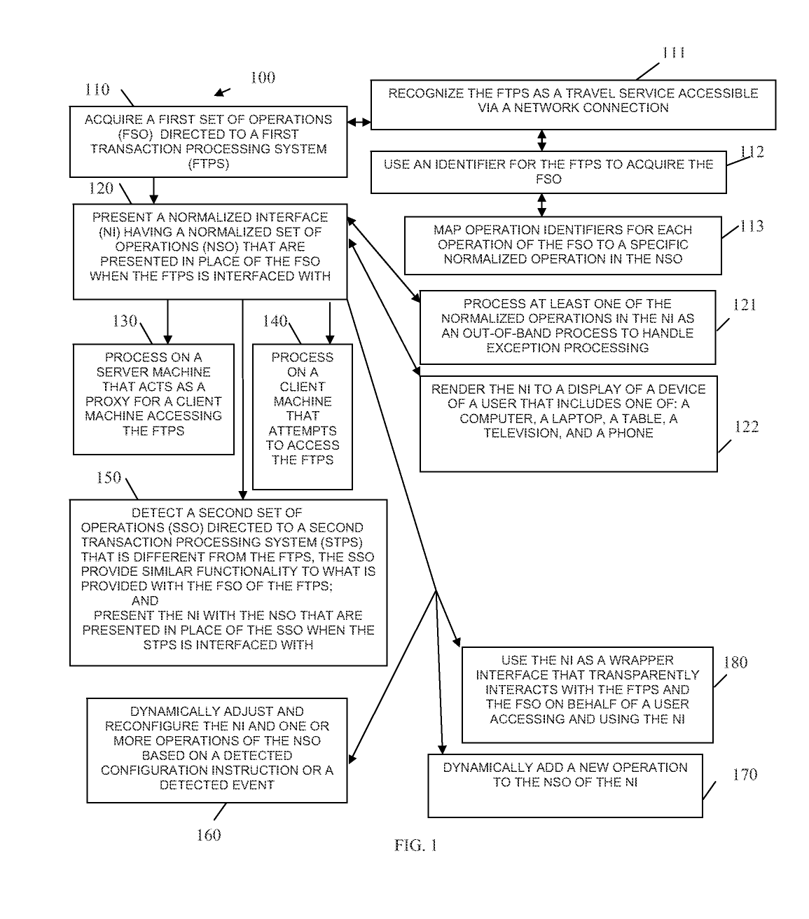

FIG. 1 is a diagram of a method 100 for providing a normalized interface to a transaction processing system, according to an example embodiment. The method 100 (hereinafter “interface controller”) is implemented as instructions programmed and residing on a non-transitory computer-readable (processor-readable) storage medium and executed by one or more processors, server, web-based Internet portal, cloud, virtual machine (VM), etc.) over a network connection. The processors are specifically configured and programmed to process the interface controller. The interface controller may also operate over a network. The network is wired, wireless, or a combination of wired and wireless.

At 110, the interface controller acquires a first set of operations being directed to a first transaction processing system. That is, the first set of operations is associated with a front-end or first interface of the first transaction processing system. The interface controller can detect the attempt to access one of the first set of operations in a number of ways. For example, the user may directly access a link for the first transaction processing system or may manually enter a website address associated with the first transaction processing system.

According to an embodiment, at 111, the interface controller recognizes the first transaction processing system as a first travel service that a user is attempting to interact with for purposes of completing a transaction with that travel service.

Continuing with the embodiment of 111 and at 112, the interface controller uses an identifier for the first transaction processing system to look up, identify, and acquire the first set of operations, which comprise a first interface for the first transaction processing system.

Still continuing with the embodiment of 112 and at 113, the interface controller maps operation identifiers for each operation in the first set of operations to a specific operation in the normalized set of operations for the normalized interface (normalized set of operations and normalized interface discussed below at 120).

At 120, the interface controller presents a normalized interface having a normalized set of operations to a user via a display on a device of the user. The normalized set of operations are presented and provided in place of an instead of the first set of operations that the first transaction processing system provides via its normal front-end interface. The normalized set of operations is presented when the user attempts to interact with the first transaction processing system. The user believes that the user is in fact directly interacting with the first transaction processing system when the user is actually interacting with the interface controller via the presented normalized interface.

In an embodiment, at 121, the interface controller processes at least one of the operations in the normalized set of operations as an out-of-band process to handle some exception scenarios. That is, some operations in the first set of operations for the first transaction processing system may not be normalized and in such scenarios out-of-band processing exceptions can be used. The interface controller is entirely customizable and even capable of being dynamically reconfigured.

According to an embodiment, at 122, the interface controller renders the normalized interface directly to a display of a device being used by the user to access the first transaction processing system. In some cases, this can occur via a specific application processing on the device of the user, such as a web browser.

In an embodiment, at 130, the interface controller is processed on a server machine that acts as a proxy for a client machine being used by the user. The client machine used by the user to access the first transaction processing system.

In an alternative scenario, at 140, the interface controller is processed on a client machine of the user. That is, the device that the user uses to access the first transaction processing system is the same device or machine where the interface controller is processed. In some cases, the interface controller may be a plugin to a web browser on the client machine of the user.

In one case, at 150, the interface controller detects a second set of operations directed to a second transaction processing system coming from the same user as what was discussed at 110. Here, the interface controller presents the normalized interface again with the normalized set of operations in place of the second set of operations and permits the user to interact with both the first and second transaction processing systems via the single normalized interface. The first and second transaction processing systems can also be disparate from one another and incompatible with one another.

In another situation, at 160, the interface controller dynamically adjusts and reconfigures the normalized interface and one or more operations of the normalized set of operations based on a detected configuration instruction or a detected event. So, the features and look-and-feel of the normalized interfaced can be adjusted and augmented in real time and dynamically on-the-fly.

In one case, at 170, the interface controller dynamically adds a new operation to the normalized set of operations for the normalized interface.

According to an embodiment, at 180, the interface controller uses the normalized interface as a wrapper interface to the first transaction processing system. The wrapper interface transparently interacts with the first set of operations of the first transaction processing system via the normalized set of operations of the normalized interface on behalf of the user.

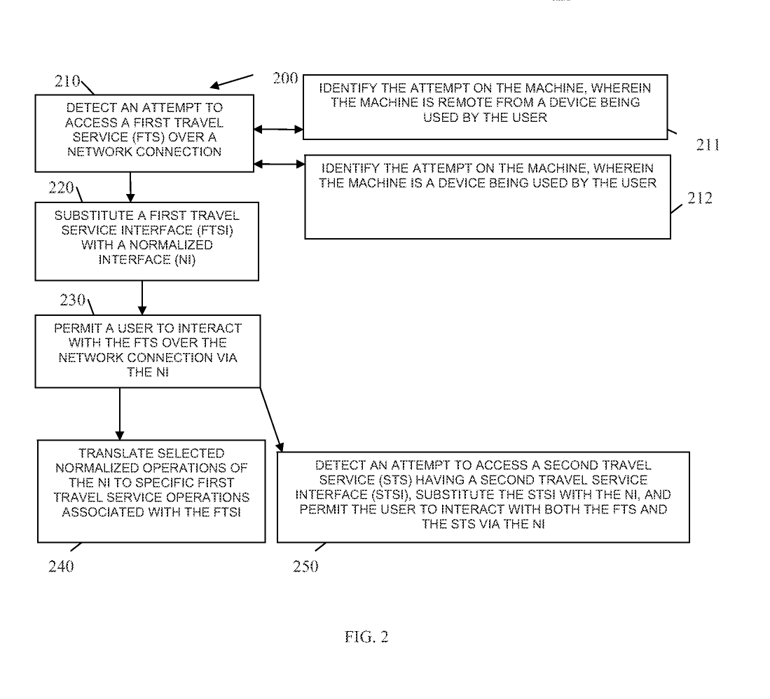

FIG. 2 is a diagram of another method 200 for providing a normalized interface to a transaction processing system, according to an example embodiment. The method 200 (hereinafter “interface provider”) is implemented as instruction and programmed within a non-transitory computer-readable (processor-readable) storage medium that executes on one or more processors of a network-based machine or stand-alone machine; the processors of the machine are specifically configured to execute the interface provider. The interface provider may also be operational over a network; the network is wired, wireless, or a combination of wired and wireless.

The processing of the interface provider reflects enhanced and different aspects of the interface controller represented by the method 100 of the FIG. 1.

At 210, the interface provider detects an attempt to access a first travel service over a network connection.

According to an embodiment, at 211, the interface provider identifies the attempt on a machine that is different from the machine that the user uses to make the attempt. In this case, the interface provider processes on a remote machine over the network connection.

In another case, at 212, the interface provider identifies the attempt on a same machine that the user uses to make the attempt. Here, the processing of the interface provider is integrated into the same device that the user uses. For example, the interface provider may be a plugin to a browser application on the user's device (phone, laptop, computer, tablet, etc.).

At 220, the interface provider substitutes a first travel service interface with a normalized interface. That is the travel service is accessed via the first travel service interface and when the user attempts to access that interface, the interface provider substitutes the normalized interface in place of the first travel service interface.

At 230, the interface provider permits a user to interface with the first travel service over the network connection using the normalized interface.

According to an embodiment, at 240, the interface provider translates user-selected normalized operations of the normalized interface into specific first travel-service operations of the first travel service interface.

In an embodiment, at 250, the interface provider detects another attempt of the user to access a second travel service over the network connect. The interface provider then substitutes a second travel service interface of the second travel service to the normalized interface and permits the user to interact with both the first and second travel services, via the single normalized interface.

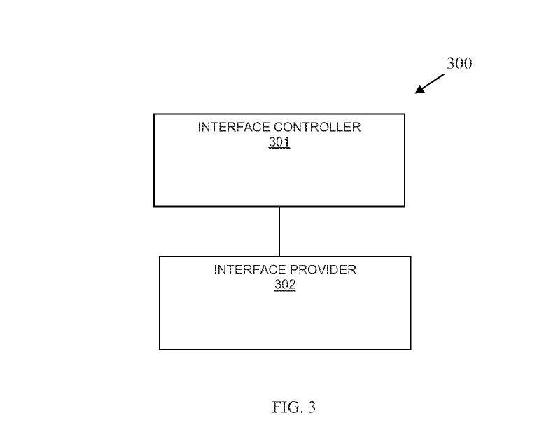

FIG. 3 is a diagram of a normalized interface system 300, according to an example embodiment. The components of the normalized interface system 300 are implemented as executable instructions and programmed within a non-transitory computer-readable (processor-readable) storage medium that execute on one or more processors of a network-based server (cloud, proxy, Virtual Machine (VM), etc.) or a standalone machine (client device (laptop, tablet, computer), cashier-manned checkout station, self-service checkout station, kiosk, etc.); the processors are specifically configured to execute the components of the normalized interface system 300. The normalized interface system 300 may also be operational over a network; the network is wired, wireless, or a combination of wired and wireless.

The normalized interface system 300 includes an interface controller 301 and an interface provider 302. Each of these components and the interactions of each component are now discussed in turn.

The normalized interface system 300 includes a one or more network-based or standalone machine processors accessible, which can be accessible over a network connection. The one or more processors include execution instructions for the interface controller 301, which resides and is programmed within a non-transitory computer-readable storage medium and processed on the one or more processors. Example processing associated with the interface controller 301 was presented in detail above with reference to the FIG. 1.

The interface controller 301 is configured to map first operations associated with a first interface of a first transaction processing system to normalized operations associated with a normalized interface.

According to an embodiment, the interface controller 301 is configured to map second operations associated with a second interface of a second transaction processing system to the normalized operations of the normalized interface, and wherein the interface provider 302 is configured to present the normalized interface on the display of the device of a user and act as the intermediary, via the normalized interface, between the user and the first and second transaction processing systems.

The normalized interface system 300 also includes a one or more network-based or standalone machine processors, which may also be accessible over a network connection. The one or more processors include execution instructions for the interface provider 302, which resides and is programmed within a non-transitory computer-readable storage medium and processed on the one or more processors. Example processing associated with the interface provider 302 was presented in detail above with reference to the FIG. 2.

The interface provider 302 is configured to present the normalized interface on a display of a device of a user and act as an intermediary, via the normalized interface, between the user and the first transaction processing system.

In an embodiment, the interface controller 301 and the interface provider 302 process on the processor embedded in a machine that is remote from a device of the user.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors of a machine configured to execute the method, comprising:
acquiring, at the machine, a first set of operations directed to a first transaction processing system;
presenting, via the machine, a normalized interface having a normalized set of operations that are presented in place of the first set of operations when the first transaction processing system is interfaced with.

2. The method of claim 1 further comprising, processing the method on a server machine that acts as a proxy for a client machine accessing the first transaction processing system.

3. The method of claim 1 further comprising, processing the method on a client machine that attempts to access the first transaction processing system.

4. The method of claim 1 further comprising:
detecting, by the machine, a second set of operations directed to a second transaction processing system that is different from the first transaction processing system, the second set of operations provide similar functionality to what is provided with the first set of operations of the first transaction processing system; and
presenting, via the machine, the normalized interlace with the normalized set of operations that are presented in place of the second set of operations when the second transaction processing system is interfaced with.

5. The method of claim 1 further comprising, dynamically adjusting and reconfiguring, via the machine, the normalized interface and one or more operations of the normalized set of operations based on a detected configuration instruction or a detected event.

6. The method of claim 1 further comprising, dynamically adding, via the machine, a new operation to the normalized set of operations of the normalized interface.

7. The method of claim 1 further comprising, using, via the machine, the normalized interface as a wrapper interface that transparently interacts with the first transaction processing system and the first set of operations on behalf of a user accessing and using the normalized interface.

8. The method of claim 1, wherein acquiring further includes recognizing the first transaction system as a travel service accessible via a network connection.

9. The method of claim 8, wherein recognizing further includes using an identifier for the first transaction system to acquire the first set of operations.

10. The method of claim 9, wherein using further includes mapping operation identifiers for each operation of the first set of operations to a specific normalized operation in the normalized set of operations.

11. The method of claim 1, wherein presenting further includes processing at least one of the normalized operations in the normalized interface as an out-of-band process to handle exception processing.

12. The method of claim 1, wherein presenting further includes rendering the normalized interface to a display of a device of a user that includes one of: a computer, a laptop, a table, a television, and a phone.

13. A processor-implemented method programmed in a non-transitory processor-readable medium and to execute on one or more processors of a machine configured to execute the method, comprising:
detecting, at the machine, an attempt to access a first travel service over a network connection;
substituting, at the machine, a first travel service interlace with a normalized interface: and
permitting, at the machine, a user to interact with the first travel service over the network connection via the normalized interface.

14. The method of claim 13 further comprising, translating, via the machine, selected normalized operations of the normalized interface to specific first travel service operations associated with the first travel service interface.

15. The method of claim 13 further comprising, detecting, at the machine, an attempt to access a second travel service having a second travel service interface, substituting, at the machine, the second travel service interface with the normalized interface, and permitting, at the machine, the user to interact with both the first travel service and the second travel service via the normalized interface.

16. The method of claim 13, wherein detecting further includes identifying the attempt on the machine, wherein the machine is remote from a device being used by the user.

17. The method of claim 13, wherein detecting further includes identifying the attempt on the machine, wherein the machine is a device being used by the user.

18. A system comprising:
a processor configured with an interface controller implemented within a non-transitory computer-readable storage medium and that executes on the processor; and
the processor configured with an interface provider implemented within a non-transitory computer-readable storage medium and that executes on the processor;
wherein the interface controller is configured to map first operations associated with a first interface of a first transaction processing system to normalized operations associated with a normalized interface, and wherein the interface provider is configured to present the normalized interface on a display of a device of a user and act as an intermediary, via the normalized interface, between the user and the first transaction processing system.

19. The system of claim 18, wherein the interface controller is configured to map second operations associated with a second interface of a second transaction processing system to the normalized operations of the normalized interface, and wherein the interface provider is configured to present the normalized interface on the display of the device of a user and act as the intermediary, via the normalized interface, between the user and the first and second transaction processing systems.

20. The system of claim 18, wherein the interface controller and the interface provider process on the processor embedded in a machine that is remote from a device of the user.
